(19) United States
(12) Patent Application Publication
(10) Pub. No.: US 2025/0054409 A1
(43) Pub. Date: Feb. 13, 2025

(54) APPARATUS AND METHOD FOR PROVIDING BATHING INSTRUCTIONS

(71) Applicants: Hilda Sonia DeBride, Glendale, AZ (US); Andres Rodriguez DeBride, Glendale, AZ (US)

(72) Inventors: Hilda Sonia DeBride, Glendale, AZ (US); Andres Rodriguez DeBride, Glendale, AZ (US)

(21) Appl. No.: 18/231,281

(22) Filed: Aug. 8, 2023

(51) Int. Cl. G09B 19/00; G09B 5/06

(52) U.S. Cl. CPC G09B 19/0076; G09B 5/065

(57) ABSTRACT

An instructional apparatus for providing instructions to an individual for bathing includes a housing and a control circuit being mounted in the housing. A display screen is electrically coupled to the control circuit and is mounted to a front side of the housing. The control circuit is programmed when actuated to display on the display screen a sequence of images indicating a sequence of a plurality of areas of a body of an individual to be cleaned. A method of using the instructional apparatus to instruct the individual to wash the individual's body is also claimed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to instructional apparatus and more particularly pertains to a new instructional apparatus for providing instructions to an individual for bathing.

### (2) Description of Related Art Including Information Disclosed Under 37 CFR 1.97 and 1.98

Children and those with cognitive disabilities such as dementia, autism, and down syndrome often need to be taught or reminded how to complete daily tasks such as washing their bodies. Some individuals with cognitive disabilities that affect memory and attention in particular may need the reminders to remain focused on the present task and to indicate which step of the task needs to be completed next. The prior art addresses this issue generally with devices which provide visual or audible reminders. Additionally, the prior art includes control devices with screens to be placed in showers and bathtubs to control the water releasing elements of the shower or bathtub. However, the prior art fails to describe an instructional apparatus which provides visual and audible instructions for washing an individual's body which is positioned in a shower or bathtub so that the individual may follow the instructions while completing the task.

### BRIEF SUMMARY OF THE INVENTION

An embodiment of the disclosure meets the needs presented above by generally comprising a housing and a control circuit being mounted in the housing. A display screen is electrically coupled to the control circuit and is mounted to a front side of the housing. The control circuit is programmed when actuated to display on the display screen a sequence of images indicating a sequence of a plurality of areas of a body of an individual to be cleaned.

Another embodiment of the disclosure includes a method of instructing an individual to wash a body of the individual. The method comprises displaying, via a display screen of an instructional apparatus, a sequence of images indicating a sequence of a plurality of areas of the body of the individual to be cleaned. A sequence of audible instructions to sequentially clean the plurality of areas of the body of the individual also may be emitted by a sound emitter of the instructional apparatus. If so, each image of the sequence of images may be displayed synchronously with the emission of a corresponding one of the plurality of audible instructions. The instructional apparatus may be mounted to a wall near the individual and may include an input for controlling the instructional apparatus, including making various selections which affect the manner in which the sequence of images and the sequence of audible instructions are displayed and emitted respectively.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of an instructional apparatus according to an embodiment of the disclosure.

FIG. 2 is a front view of an embodiment of the disclosure.

FIG. 3 is a back view of an embodiment of the disclosure.

FIG. 4 is a bottom view of an embodiment of the disclosure.

FIG. 5 is a block diagram of an embodiment of the disclosure.

### DETAILED DESCRIPTION OF THE INVENTION

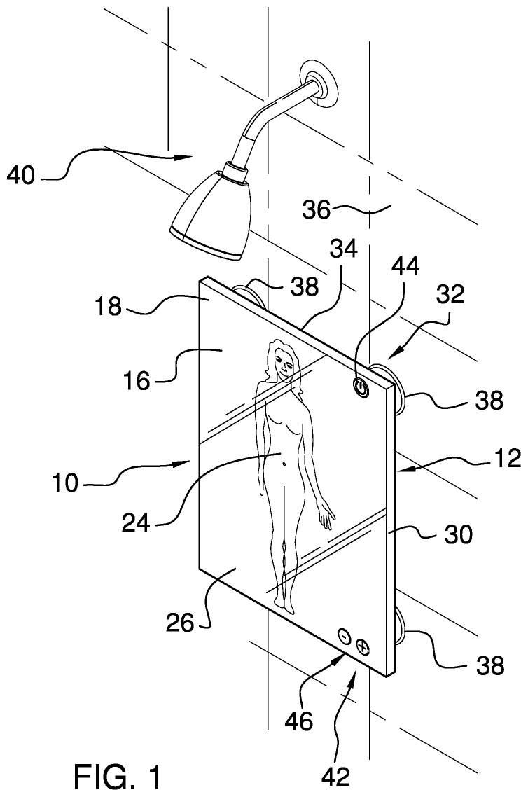

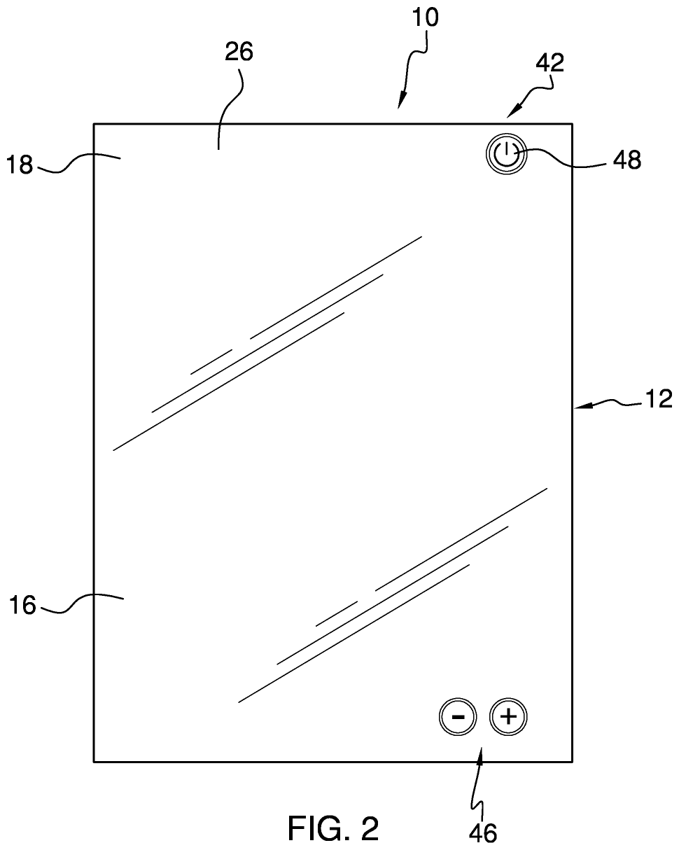

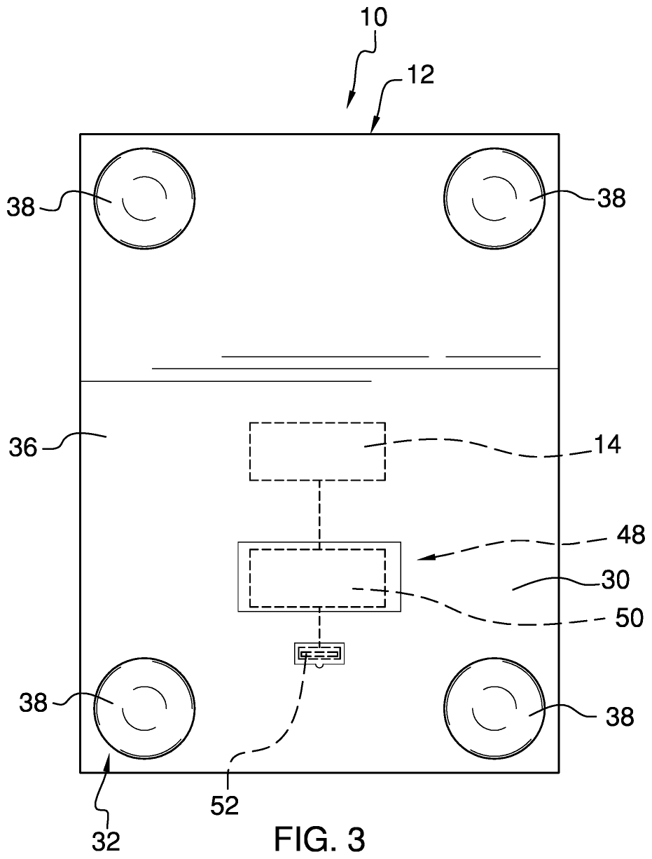

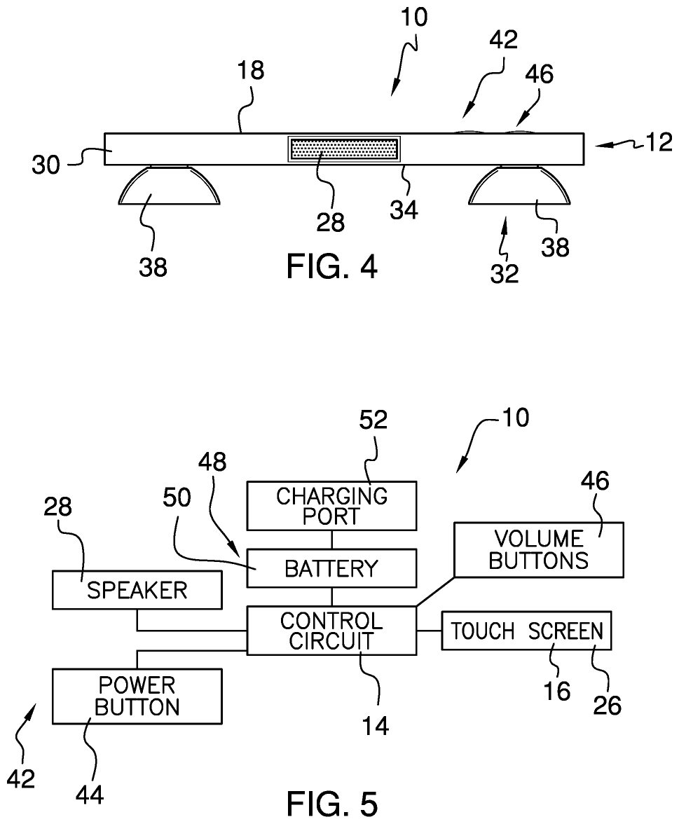

With reference now to the drawings, and in particular to FIGS. 1 through 5 thereof, a new instructional apparatus embodying the principles and concepts of an embodiment of the disclosure and generally designated by the reference numeral 10 will be described.

As best illustrated in FIGS. 1 through 5, the instructional apparatus 10 generally comprises a housing 12 and a control circuit 14 mounted in the housing 12. A display screen 16 is electrically coupled to the control circuit 14 and is mounted to a front side 18 of the housing 12. The control circuit 14 is programmed when actuated to display on the display screen 16 a sequence of images indicating a sequence of a plurality of areas of a body of an individual to be cleaned. The sequence of images may include an image of a human body 24 with arrows, highlighting colors, circles, or other indications designed to direct the individual's attention to an area of the human body 24 corresponding to one of the plurality of areas of the individual's body to be cleaned. Other examples of indications may be a graphical image of water, soap, or soap suds being shown overlaying or adjacent to the area of the human body 24. The sequence of images also may include an animation of the human body 24 cleaning the area of the human body 24.

The display screen 16 also comprises a touchscreen 26 configured for receiving instructions to control the control circuit 14. A sound emitter 28 is electrically coupled to the control circuit 14 and is mounted to an exterior 30 of the housing 12. The control circuit 14 is programmed to emit a sequence of audible instructions with the sound emitter 28 to sequentially clean the plurality of areas of the body of the individual. Each image of the sequence of images is displayed synchronously with the emission of a corresponding one of the plurality of audible instructions.

A mount 32 is coupled to the housing 12 and is positioned on a back side 34 of the housing 12 for mounting the housing 12 to a wall 36. The mount 32 comprises at least one suction cup 38 but may comprise a threaded fastener, an adhesive, a hook-and-loop fastener, or other conventional mounting means. The housing 12 may be removable from the wall 36, or the attachment of the housing 12 to the wall 36 may be permanent or semi-permanent. The wall 36 is a surface located such that the individual can see the display screen 16, hear the audible instructions, or both while the individual is positioned in a bathtub, a shower 40, a wet room, or the like. For example, the housing 12 may be mounted to a shower wall or a bathroom wall adjacent to the shower 40 or the bathtub.

An input 42 is electrically coupled to the control circuit 14 and comprises a power button 44 and a volume control 46. The power button 44 and the volume control 46 are mounted to the exterior 30 of the housing 12. The power button 44 is actuatable to turn the control circuit 14 alternately on and off, and the volume control 46 is actuatable to control a volume of sound emitted by the sound emitter 28. A power supply 48 is electrically coupled to the control circuit 14 and is positioned in the housing 12. The power supply 48 comprises a battery 50 which is chargeable by an external power source via a charging port 52 positioned on the exterior 30 of the housing 12. Seals are formed throughout the exterior 30 of the housing 12 to prevent water from entering the housing 12. The sound emitter 28 and charging port 52 are constructed to resist water damage, which may include providing seals to prevent entry of water to water-damageable components and being constructed of materials that will resist damage from contact with water.

The control circuit 14 may be programmed to receive commands via the touchscreen 26 or other input 42 means to make various selections concerning the sequence of images and the sequence of audible instructions. For example, if the sequence of images includes the image of the human body 24, sexual characteristics of the human body 24 may be chosen, and this selection may be made such that the sexual characteristics of the human body 24 coincide with sexual characteristics of the body of the individual. So, for example, the image of the human body 24 may be selected to depict a male body if the individual is male. The human body 24 may also be selected to be shown without any particular sexual characteristics. Other characteristics of the body of the individual may be selected, such as whether the individual has long hair, short hair, or is bald. Such other characteristics may be depicted in the sequence of images and referenced in the sequence of audible instructions.

Different cleaning tools such as a loofa, a towel, an exfoliating glove, a hand, or the like may be selected to be visually depicted by the display screen 16 and referenced in the sequence of audible instructions. A total time period for the sequence of images and the sequence of audible instructions to be displayed and emitted respectively may be selected. Particular time periods for particular images of the sequence of images and particular audible instructions of the sequence of audible instructions may be selected. The different cleaning tools, the other characteristics of the body of the individual, and other selections may alter the total and particular time periods. Selections may also be made concerning the language used in the audible instructions (e.g., English, French, German, etc.) and word choice for particular audible instructions of the sequence of audible instructions (e.g., “rear end,” “bottom,” “buttocks,” etc.). The control circuit 14 may be programmed to be actuated to store profiles containing the various selections in a memory of the control circuit 14 which correspond to different individuals of a plurality of individuals.

In use, the various selections may be made and stored in one of the profiles. One of the profiles may be selected. The sequences of images and the audible instructions are initiated, which direct the individual to clean the individual's body. A description of an example instruction sequence follows in the table below. The visual and aural components of each step in the example instruction sequence occur simultaneously.

| | | Examples of verbal commands giving |
|---|---|---|
| | Description of images displayed by the | audible instructions emitted by the |
| | display screen 16 | sound emitter 28 |
| 1. | Water falling on a head of the human | “Wet hair.” |
| | body 24 | |
| 2. | Shampoo/bubbles and a hand of the | “Wash hair. Make sure to wash the |
| | human body 24 positioned on the head | front, the sides, and the back.” |
| | of the human body 24 | |
| 3. | Water falling on the head of the human | “Rinse hair. Make sure to rinse the |
| | body 24 | front, the sides, and the back.” |
| 4. | Soap/bubbles and the hand on a face of | “Wash face. Don't forget to use soap. |
| | the human body 24 | Don't forget to wash behind your |
| | | ears.” |
| 5. | Soap/bubbles and the hand on a neck of | “Wash neck. Don't forget the back of |
| | the human body 24 | the neck.” |
| 6. | Water and the hand on the face and the | “Rinse face and neck.” |
| | neck. | |
| 7. | Nothing displayed. | “Now it's time to wash your body.” |
| 8. | A cleaning tool, such as a loofa, a towel, | “Put soap on [the cleaning tool].” |
| | a glove, a hand, or the like with | |
| | soap/bubbles. | |
| 9. | The cleaning tool and soap/bubbles | “Wash chest.” |
| | positioned on a chest of the human | For a female body: “Wash chest and |
| | body 24. | wash under your breasts.” |
| 10. | Water falling on the chest. | “Rinse chest.” |
| | | For a female body: “Rinse chest and |
| | | breasts.” |
| 11. | The cleaning tool with soap/bubbles. | “Put soap on [the cleaning tool].” |
| 12. | Indication of underarms of the human | “Now it's time to wash your |
| | body 24. May sequentially indicate each | underarms.” May sequentially direct |
| | underarm. | the individual to clean each underarm. |
| 13. | Water falling onto the underarms. | “Now face the water and rinse your |
| | | underarms. Make sure to rinse all the |
| | | soap from each underarm.” |
| 14. | Indication of arms of the human | “Now let's wash our arms.” May |
| | body 24. May sequentially indicate each | sequentially direct the individual to |
| | arm. | clean each arm. May include “Don't |
| | | forget the elbow.” |
| 15. | Water falling onto the arms. | “Now face water and rinse your arms.” |
| 16. | Indication of abdomen. | “Now it's time to wash your |
| | | abdomen.” |
| 17. | The cleaning tool with soap/bubbles. | “Add soap to [the cleaning tool.]” |
| 18. | The cleaning tool and soap/bubbles | “Wash your belly and belly button.” |
| | positioned on the abdomen. | May include: “Lift and wash under |
| | | your belly.” |
| 19. | Water falling on the abdomen. | “Now face the water and rinse your |
| | | belly.” |
| 20. | Indication of genitalia of the human | “Now it's time to wash your genitalia.” |
| | body 24. | |
| 21. | The cleaning tool with soap/bubbles. | “Add soap to [the cleaning tool].” |
| 22. | The cleaning tool and soap/bubbles | “Wash your genitalia.” |
| | positioned on the genitalia. | For a male body: “Make sure you wash |
| | | from the tip of your penis to the pubic |
| | | hair area. Then lift up the penis and |
| | | scrub the testicles and underneath the |
| | | testicles.” |
| 23. | Water falling on the genitalia. | “Now rinse your genitalia.” |
| 24. | Indication of a back and a pair of | “Now let's wash your backside.” |
| | buttocks of the human body 24. | |
| 25. | The cleaning tool with soap/bubbles. | “Add soap to [the cleaning tool.]” |
| 26. | The cleaning tool and soap/bubbles | “Let's start with your back. Reach as |
| | positioned on the back and the buttocks. | far as you can and scrub. Move down |
| | | to your buttocks and scrub in |
| | | between.” |
| 27. | Water falling on the back and the | “Now rinse your backside.” |
| | buttocks. | |
| 28. | Indication of legs of the human | “Now let's wash our legs.” |
| | body 24. | |
| 29. | The cleaning tool with soap/bubbles. | “Add soap to [the cleaning tool.]” |
| 30. | The cleaning tool and soap/bubbles | “Wash your legs.” May sequentially |
| | positioned on the legs. | direct the individual to clean each leg. |
| 31. | Water falling on the legs. | “Rinse legs.” |
| 32. | Indication of feet of the human body 24. | “Finally, we are going to wash our |
| | | feet.” |
| 33. | The cleaning tool with soap/bubbles. | “Add soap to [the cleaning tool.]” |
| 34. | The cleaning tool and soap/bubbles | “Wash your feet.” May sequentially |
| | positioned on the feet. | direct the individual to wash each foot. |
| | | May include: “Don't forget between |
| | | your toes.” |
| 35. | Water falling on the feet | “Rinse your feet.” |
| 36. | Nothing displayed. | “You are finished. Turn off water.” |

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An instructional apparatus for providing instructional cues to an individual to wash a body of the individual, the apparatus comprising:
a housing;
a control circuit being mounted in the housing; and
a display screen being electrically coupled to the control circuit, the display screen being mounted to a front side of the housing, the control circuit being programmed when actuated to display on the display screen a sequence of images indicating a sequence of a plurality of areas of the body of the individual to be cleaned.

2. The apparatus of claim 1, wherein the display screen comprises a touchscreen configured for receiving instructions to control the control circuit.

3. The apparatus of claim 1, further comprising a sound emitter being electrically coupled to the control circuit, the sound emitter being mounted to an exterior of the housing, the control circuit being programmed to emit a sequence of audible instructions with the sound emitter to sequentially clean the plurality of areas of the body of the individual.

4. The apparatus of claim 3, wherein each image of the sequence of images is displayed synchronously with the emission of a corresponding one of the plurality of audible instructions.

5. The apparatus of claim 1, further comprising a mount being coupled to the housing for mounting the housing to a wall, the mount being positioned on a back side of the housing.

6. The apparatus of claim 5, wherein the mount comprises at least one suction cup.

7. The apparatus of claim 1, further comprising an input being electrically coupled to the control circuit.

8. The apparatus of claim 7, wherein the input comprises a power button mounted to the exterior of the housing for turning the control circuit alternately on and off.

9. The apparatus of claim 7, wherein the input comprises a volume control mounted to the exterior of the housing for controlling a volume of sound emitted by the sound emitter.

10. The apparatus of claim 1, further comprising a power supply being electrically coupled to the control circuit and being positioned in the housing.

11. The apparatus of claim 10, wherein the power supply comprises a battery.

12. The apparatus of claim 11, further comprising a charging port being electrically coupled to the battery and being positioned on the exterior of the housing, the charging port being configured for electrically coupling to an external power source to charge the battery.

13. An instructional apparatus for providing instructional cues to an individual to wash a body of the individual, the apparatus comprising:
a housing;
a control circuit being mounted in the housing;
a display screen being electrically coupled to the control circuit, the display screen being mounted to a front side of the housing, the control circuit being programmed when actuated to display on the display screen a sequence of images indicating a sequence of a plurality of areas of the body of the individual to be cleaned, the display screen comprising a touchscreen configured for receiving instructions to control the control circuit;
a sound emitter being electrically coupled to the control circuit, the sound emitter being mounted to an exterior of the housing, the control circuit being programmed to emit a sequence of audible instructions with the sound emitter to sequentially clean the plurality of areas of the body of the individual, each image of the sequence of images being displayed synchronously with the emission of a corresponding one of the plurality of audible instructions;
a mount being coupled to the housing for mounting the housing to a wall, the mount being positioned on a back side of the housing, the mount comprising at least one suction cup;
an input being electrically coupled to the control circuit, the input comprising:
a power button mounted to the exterior of the housing for turning the control circuit alternately on and off; and
a volume control mounted to the exterior of the housing for controlling a volume of sound emitted by the sound emitter;
a power supply being electrically coupled to the control circuit and being positioned in the housing, the power supply comprising a battery; and
a charging port being electrically coupled to the battery and being positioned on the exterior of the housing, the charging port being configured for electrically coupling to an external power source to charge the battery.

14. A method of instructing an individual to wash a body of the individual, the method comprising displaying, via a display screen of an instructional apparatus, a sequence of images indicating a sequence of a plurality of areas of the body of the individual to be cleaned.

15. The method of claim 14, further comprising emitting, via a sound emitter of the instructional apparatus, a sequence of audible instructions with the sound emitter to sequentially clean the plurality of areas of the body of the individual.

16. The method of claim 15, wherein the step of emitting the sequence of audible instructions comprises each image of the sequence of images being displayed synchronously with the emission of a corresponding one of the plurality of audible instructions.

17. The method of claim 14, wherein the instructional apparatus is mounted to a wall.

18. The method of claim 14, wherein the instructional apparatus includes an input for controlling the instructional apparatus.
